(19) United States
(12) Patent Application Publication
(10) Pub. No.: US 2014/0302367 A1
(43) Pub. Date: Oct. 9, 2014

(54) BATTERY INCLUDING SPIRAL ELECTRODE ASSEMBLY AND METHOD FOR MANUFACTURING THE SAME

(71) Applicant: SANYO Electric Co., Ltd., Moriguchi-shi, Osaka (JP)

(72) Inventors: Souichirou Ueno, Hyogo (JP); Jun Kawamata, Hyogo (JP); Yoshiyuki Furukoji, Hyogo (JP)

(73) Assignees: SANYO ELECTRIC CO., LTD., Moriguchi-shi, Osaka (JP); SANYO ELECTRIC CO., LTD., Moriguchi-shi, Osaka (JP)

(21) Appl. No.: 14/354,399

(22) PCT Filed: Oct. 24, 2012
(86) PCT No.: PCT/JP2012/077404

§ 371 Date: Apr. 25, 2014

(30) Foreign Application Priority Data
Oct. 31, 2011 (JP) 2011-238564

(51) Int. Cl. H01M 10/04

(52) U.S. Cl. CPC H01M 10/0431
USPC 429/94; 29/623.1

(57) ABSTRACT

A method for manufacturing a battery comprises winding a separator to a winding core, and forming an area in which the separator is overlapped in equal to or more than two layers of the separator, joining the two layers mutually in pressure contact by pressing a projecting portion formed in a jig to the overlapped area, after the step of the joining, providing a positive electrode plate and a negative electrode plate to the winding core, and winding into a spiral form the positive electrode plate and the negative electrode plate interposing the separator therebetween, and after the step of the winding, forming a spiral electrode assembly by removing the winding core from a winding body wound into the spiral form.

### TECHNICAL FIELD

The present invention is related to a battery including a spiral electrode assembly winding into a spiral form and a method for manufacturing the same.

### BACKGROUND ART

In recent years, as power sources for mobile data terminal, for example, mobile phones, note type personal computers, tablet type computers or the like, power storage devices for home, or power supply devices for hybrid cars (HEV, PHEV) or electric vehicles (EV), a secondary battery, for example, such as a lithium ion secondary battery or a nickel-hydrogen battery are widely used. Especially, a spiral electrode assembly winding into a spiral form a positive electrode plate and a negative electrode plate interposing a separator therebetween is widely used, because the facing area between the positive electrode plate and the negative electrode plate is large and a large current can be easily outputted from a secondary battery including it.

Generally, the spiral electrode assembly is formed in the following. The positive electrode plate and the negative electrode plate are wound to the winding core, after this step, it is manufactured by removing the winding core. In this method for manufacturing, when the winding core is removed, it happens that an electrode element (the separator or the positive and negative electrode plate) wound in the innermost is pulled by the winding core and is wound in the slippage position to the external side. By internal short-circuits as quality failure, being bigger size of the spiral electrode assembly than the normal size as quality failure, or the like resulted from such winding slippage, the yield rate of manufacturing decreases.

As the way to resolve this problem, there is a way in which the winding core is coated with a parting agent. When the winding core is coated with the parting agent, as lubricity in the surface of the winding core is high, the releasability, in other words, elimination property from the winding core is also high. However, the coating effect of the parting agent is reduced by each time of using the winding core. Accordingly, it is necessary that the winding core is periodically coated with the parting agent as maintenance work. By this maintenance work, problems, for example, such as decrease of manufacturing efficiency, increase of operational errors, occur. Also, a new problem in the following occurs. Namely, for example, during this maintenance work, foreign objects (for example, metal particle) are mixed.

For example, patent Literature 1 and 2 describe techniques related to winding of the spiral electrode assembly.

### CITATION LIST

### Patent Literature

Patent Literature 1:

Japanese Laid-Open Patent Publication No. 2007-207649

Patent Literature 2:

Japanese Laid-Open Patent Publication No. 1993(=HEI05)-299120

Patent literature 1 discloses the following technique. The electrode plate group is constituted by winding a positive electrode plate and a negative electrode plate to which a lead for collecting current is fit, through a separator by using a winding core, and a portion corresponding to two laps from the innermost lap out of the separator exposed from the electrode plate width of the upper part or the bottom part of the electrode plate group is partially welded during the electrode plate winding process. This technique enables to provide a manufacturing method of a square nonaqueous electrolyte battery capable of increasing winding speed, decreasing the amount of an inner circumferential separator, and reducing the dispersion of positions of a lead for collecting current in the winding of an electrode plate group.

Patent literature 2 discloses the following technique. A porous polymeric film is used as the separator, and the separator is started to being wound, being inserted into a split of a split pin. Further in manufacturing of a cylindrical type spiral battery, a step is used to wind the negative electrode and the positive electrode of the band shapes while interposing the separator therebetween to avoid contacting therebetween. Before the separator is started to being wound at least one portion of the separator which is to be in contact with the split pin is heated at a temperature not less than a softening point and less than a melting point. This technique enables to easily separate the split pin from an electrode structural body wound in the center of the split pin without giving bad effect to the characteristic of the battery in manufacturing of a cylindrical type spiral battery.

However, even by using the techniques of patent literature 1 or 2, it is impossible to prevent winding slippage by the winding core pulling without complicated process.

### SUMMARY OF THE INVENTION

The present disclosure is developed for the purpose of solving such drawbacks. One non-limiting and explanary embodiment provides a battery or a method for manufacturing the same in which the winding slippage is suppressed or reduced at the time of removing a winding core from a spiral electrode assembly, without complicated process or periodical maintenance work.

A method for manufacturing a battery including a spiral electrode assembly of the present disclosure comprises in the following. A method comprises winding at least one sheet separator to a winding core, and forming an area in which the separator is overlapped in equal to or more than two layers of the separator, joining the two layers mutually in pressure contact by pressing a projecting portion formed in a jig to the overlapped area, after the step of the joining, providing a positive electrode plate and a negative electrode plate to the winding core, and winding into a spiral form the positive electrode plate and the negative electrode plate interposing the separator therebetween, and after the step of the winding, forming a spiral electrode assembly by removing the winding core from a winding body wound into the spiral form.

This construction is, before winding the positive electrode plate and the negative electrode plate, winding a separator to a winding core, and forming an area in which the separator is overlapped in equal to or more than two layers of the separator, joining the separators mutually in pressure contact by pressing a projecting portion formed in a jig to the overlapped area. By this, the separator directly contacting to the winding core, and the outer separator not directly contacting to the winding core are joined in pressure contact. As a result, at the time of removing the winding core from a winding body wound into the spiral form, the winding body wound into the spiral form is moved as one. Therefore, the winding slippage of the separator by the winding core pulling is suppressed or reduced.

In addition, periodical maintenance works are not necessary, the above-mentioned new problem by maintenance work does not occur.

Here, the projecting portion formed in the jig is preferably a tapering shape. In addition, preferably, the diameter in the base of the projecting portion is 5 to 30 mm, and the height of the projecting portion is 0.1 to 1.0 mm, and the plurality of such projecting portions are formed in the jig.

Further, when the separator of the innermost circumference in the spiral electrode assembly is joined in pressure contact, even if the separator is torn, the internal short does not happen. In contrast, if the positive electrode plate or the negative electrode plate is joined in pressure contact, the trouble is that the internal short happens by the torn plate penetrating the separator or the like.

Here, the area in which the separator is overlapped in equal to or more than two layers of the separator is formed, for example, when two sheets of the separators are wound at the same time, or when one sheet of the separator is wound in equal to or more than two rotations.

Preferably, the jig in which the projecting portion is formed is a roller. And the knurling is applied to the surface of the roller, then projections by knurling constitutes the projecting portion, the separators are properly joined in pressure contact each other. The knurling can be AYAME-type (the stripes of the convex shape obliquely in parallel), or HIRAME-type(the stripes of the convex shape horizontally in parallel), and AYAME-type is preferable.

In the above construction, the step of the joining is carried out by pressing the roller to the overlapped area in which the separators overlapped in equal to or more than two layers while rotating the winding core.

By pressing the roller while rotating the winding core, the pressure joining portion is formed in the large range without decreasing productivity, then the winding slippage is effectively prevented. At this time, while pressing the roller. The winding core is rotated by equal to or more than the angle 72 degrees of the winding core preferably, the angle 90 degree more preferably, the angle 180 degrees further more preferably.

A material of the projecting portion or the winding core is a metal, for example, stainless steel, hard metal, dies steel (SKD11 or the like), pre-hardened steel (NAK or the like), or a resin excellent in strength, for example, MC nylon (registered trade mark), UNILATE (registered trade mark). Especially the material of the projecting portion is preferably a metal harder than a resin in order to maintain the strength in pressure joining of the separator.

In the above construction, a hardness of a material of which the projecting portion is made is lower than a hardness of a material of which the winding core is made.

By this construction, breakage of the winding core by pressing the projection portion is suppressed or reduced. Accordingly, it prevents that broken pieces or the like by breakage of the winding core are mixed into the atmosphere of the manufacturing area, and reduces maintenance cost.

In order to keep a balance of hardness and strength of pressure joining of the separator, more preferably, the projecting portion is made of stainless steel of which the hardness is low among the above metal material, and the winding core is made of metal of which the hardness is harder than stainless steel, for example, hard metal, dies steel (SKD11 or the like), pre-hardened steel (NAK or the like).

Here, preferably, the hardness of metals is compared by using Vickers hardness, and the hardness of resins is compared by using Rockwell hardness (R scale).

In the above construction, a cross section shape of the winding core is a circle shape.

When a cross section shape of the winding core is other than a circle shape, pressure of the projection portion pressing is uneven, then pressure joining is also uneven. By the circle shape in cross section of the winding core, such trouble is prevented. Here, the circle in this disclosure means or includes a shape which is not a perfect circle, and a winding core having a slit.

A battery including a spiral electrode assembly of the present disclosure comprises in the following. A battery including a spiral electrode assembly winding into a spiral form a positive electrode plate and a negative electrode plate interposing a separator therebetween comprises an overlapped area in which the separator is overlapped in equal to or more than two layers of the separator in the center of the spiral electrode assembly, at least one pressure joining portion being formed joining in pressure contact the outer separator having the convex shape toward the winding center side to the inner separator positioned to the winding center side in the overlapped area.

In the above construction, plural pressure joining portions are provided in a square area, and a length of the square area in the longitudinal direction of the separator is equal to or more than one fifth of the circumference of the separator where the pressure joining portions are formed.

As mentioned above, in the present disclosure, the winding slippage is suppressed or reduced at the time of removing a winding core from a spiral electrode assembly by a simple method without periodical maintenance work or the like. Accordingly the productivity of the battery and the yield rate of manufacturing are increased.

### BRIEF DESCRIPTION OF DRAWINGS

FIG. 1 is a cross-sectional view illustrating a step of winding in a spiral electrode assembly using a winding core in this embodiment, FIG. 1(a) shows only the winding core, FIG. 1(b) shows a state of two layers of the separators being set in a slit (separator fixing portion) of the winding core, FIG. 1(c) shows a state of the two layers of the separators being set in the slit and being wound in a half of the circumference, FIG. 1(d) shows a state of pressing a roller to an overlapped area of the two layers of the separators.

FIG. 2 is a cross-sectional view illustrating a winding body wound to the winding core.

FIG. 3 is a cross-sectional view illustrating a modification of method for providing the separator to the winding core.

FIG. 4 is a schematic view illustrating a structure of a pressure joining portion, FIG. 4(a) shows a front view, FIG. 4(b) and FIG. 4(c) each show a partial enlarged view.

FIG. 5 is a schematic partial enlarged view illustrating a knurling roller structure used in example 1.

FIG. 6 is a schematic partial enlarged view illustrating a knurling roller structure used in example 2

### DESCRIPTION OF EMBODIMENTS

Embodiments of the present invention will be described below in detail, by exemplify a nonaqueous electrolyte battery for embodying the technical idea of the present invention. The present invention is not limited to the embodiments described below, and as long as the technical idea is not changed, it is possible to embody, properly changing.

In this embodiment, the nonaqueous electrolyte battery has the following structure. A positive electrode plate and a negative electrode plate (positive and negative electrode plates) are wound with a separator, and a spiral electrode assembly is pressed into a flat spiral electrode assembly. A nonaqueous electrolyte includes a non-aqueous solvent and an electrolyte salt. The flat spiral electrode assembly and the nonaqueous electrolyte are stored in a prismatic cell case. The prismatic cell case has a bottom and a top opening portion, and a sealing plate is press-fitted to the top opening portion of the prismatic cell case. By such press-fitted portion being laser-welded, the top opening portion of the prismatic cell case is sealed with the sealing plate. In addition, positive and negative external terminals are projected from the sealing plate, and they are each electronically connected to the positive electrode plate and the negative electrode plate by metal leads.

Besides those, in order to prevent electrically contacting between the flat spiral electrode assembly and the cell case or the sealing plate, an insulating member can be stored in the cell case. And in the sealing plate, safety structures releasing gas or cutting off a current at the time of increased internal pressure in the battery can be provided. Further, the surface of the cell case can be covered by an insulating material.

This embodiment has the feature in the method for manufacturing the spiral electrode assembly with the positive and negative electrode plates and the separator, and in materials of the battery or steps of manufacturing the batter other than the spiral electrode assembly, public known materials or methods are available.

The feature of this embodiment, namely, the method for manufacturing the spiral electrode assembly with the positive and negative electrode plates and the separator is concretely explained in detail using figures.

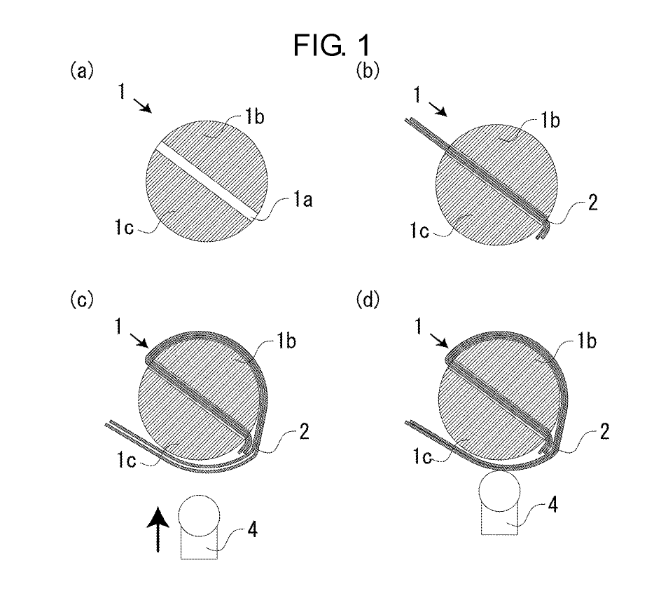

FIG. 1 is a cross-sectional view illustrating a step of winding in the spiral electrode assembly using a winding core in this embodiment, FIG. 1(a) shows only the winding core, FIG. 1(b) shows a state of two sheet of the separators being set in a slit (separator fixing portion) of the winding core, FIG. 1(c) shows a state of the two sheets of the separators being set in the slit and being wound in a half of the circumference, FIG. 1(d) shows a state of pressing a roller to an overlapped area of the two sheets of the separators. Here as the two sheets of the separators are used, the area of winding the two sheets of the separators in the circumference is the overlapped area and the two layers of the separator. Moreover, the slit is indispensable to the winding core. However, in order to prevent the separator from freely moving at the start of winding, it is preferable that the separator fixing portion of a grip, a slit or the like fixing or sandwiching the separator is provided in the winding core.

As shown in FIG. 1(a), the winding core 1 in this embodiment is a circle in the cross section, and the slit 1a is provided along a diameter, and by this, the winding core 1 is divided into divided portions 1b, 1c.

(Step of Separator Insertion)

As shown in FIG. 1(b), two sheets of the separators 21 penetrate and are inserted into the slit 1a, and an end portion of the separators is bent and pressed to the one divided portion 1c.

(Step of Wingding)

As shown in FIG. 1(c), first of all, through rotating the winding core by one rotation, the separators are wound to the one divided portion 1c of the winding core 1 divided by the slit. Then the end portion of the separator 2 is fixed by the outer separator 2 wound outside the end portion.

(Step of Joining)

The roller 13 to which knurling is applied constitutes the jig 4. At this time, the roller 13 is pressed to the separators (the overlapped area) wound to the winding core 1, then those separators are joined in pressure contact. After this, further the winding core 1 is rotated while pressing the roller 13 to which knurling is applied to the separators wound to the winding core 1 (see FIG. 1(d)). Here, at least one projection in a knurling portion formed on the roller 13 constitutes the projecting portion in this embodiment. Especially, plural projections of the knurling portion each constitute the projecting portion in this embodiment. This step of joining is carried out in the normal temperature, so the pressure joining portion between the separators is not melted like thermal welting.

(Step of Winding)

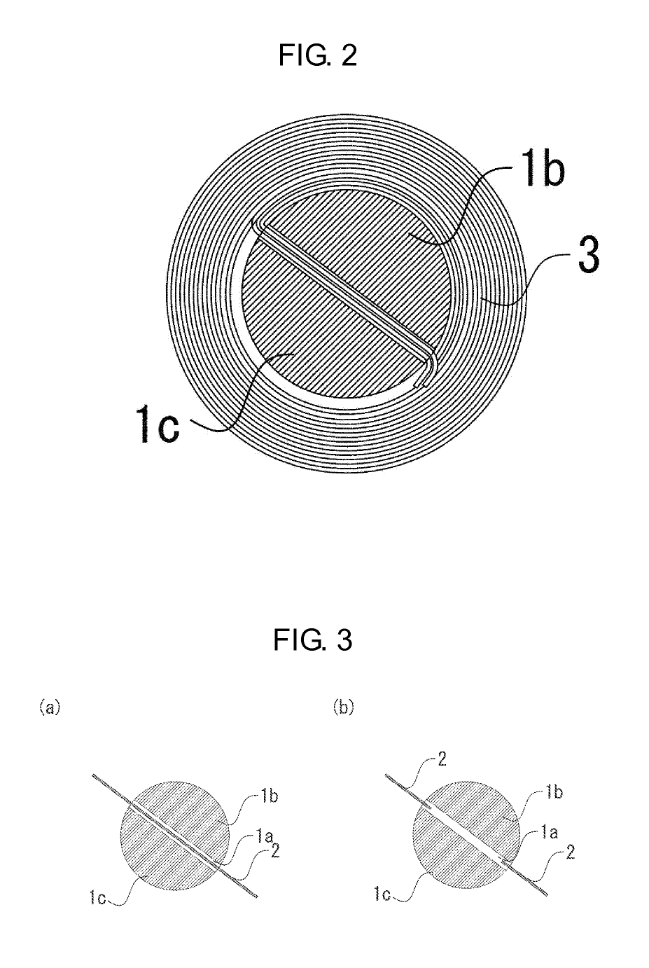

Next, the positive electrode plate and the negative electrode plate are providing such that the separator 2 is positioned at both surfaces of each of the positive plate and the negative electrode plate, further by the winding core 1 being rotated, the positive electrode plate and the negative electrode plate are wound, then a spiral electrode assembly wound to the winding core is formed (see FIG. 2). Namely, the positive electrode plate and the negative electrode plate interposing the separator therebetween are wound into a spiral form.

(Step of Removing Winding Core)

Next, the spiral electrode assembly is completed by removing the winding core from the winding body 3 wound into the spiral form.

The method of providing the separator to the winding core 1 is not limited to this. For example, as shown in FIG. 3(a), the separator 2 can be provided such that the center of one sheet of the separator 2 is set at the slit 1a of the winding core 1. For example, as shown in FIG. 3(b), the separator 2 can be provided such that each end of two sheets of the separator 2 is set within the slit 1a of the winding core 1.

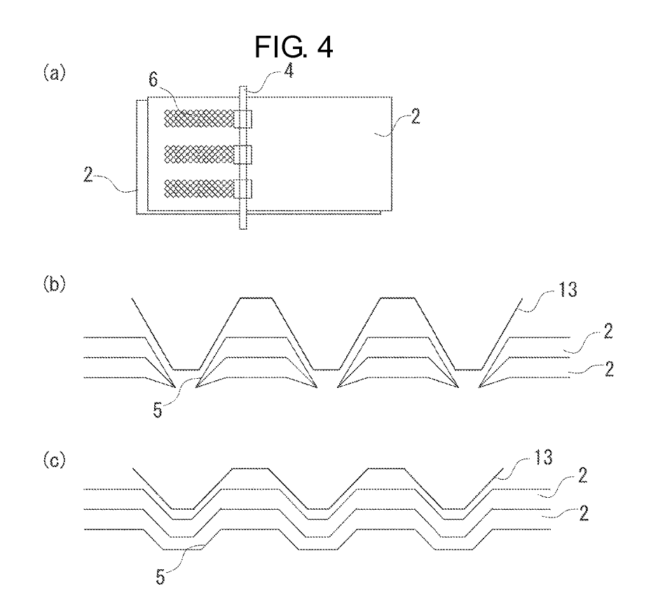

FIG. 4 is a schematic view illustrating a structure of a pressure joining portion, FIG. 4(a) shows a front view, FIG. 4(b) and FIG. 4(c) each show a partial enlarged view.

When by pressing the roller 13 of the jig 4 to which knurling is applied to the overlapped area of the separators 2, joining in pressure contact is carries out, in a square area (a pressure joining portion formed area) 6 corresponding to an area (roller width W×pressing length L), a pressure joining portion is formed (see FIG. 4(a)). As at this time the roller 13 to which knurling is applied presses the separators 2 to the winding core side (the center of winding), joining in pressure contact, plural pressure joining portions deformed or ruptured in a convex shape to the winding center side are formed (see FIG. 4(b), (c)). Further, in FIG. 4(b), (c), in the overlapped area of the separators 2, both of the outer separator and the inner separator positioned to the winding center side have pressure joining portions of the convex shape to the winding center side. However, only the outer separator can have pressure joining portions of the convex shape to the winding center side, the inner separator positioned to the winding center side noes not necessarily have the convex shape to the winding center side. In such case, the convex shape portion of the outer separator can be press-fitted into the inside of the inner separator to the winding center side.

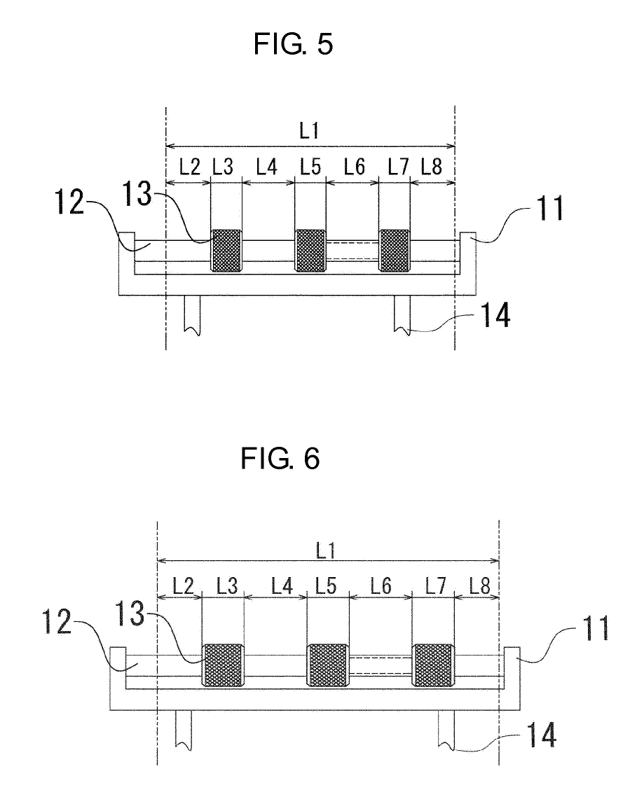

The jig used in the step of the joining is explained in FIG. 5. The jig comprises an axle portion 14 and a head portion 11, and the at least one roller 13 having the knurling surface is set to a roller axle portion 12 provided to the head portion 11. In this figure, 3 pieces of the rollers 15 are provided.

The rollers 13 are equally pressed to the separator of the width L1, preferably, for example, so as to be L2=L8 in the lengths as show in FIG. 5. Moreover, preferably, each width L3, L5, L7 of the rollers 13 is the same each other, and each interval L4, L6 between the rollers 13 is the same each other.

Here, the ratio of the total (L3+L5+L7) of the widths of the rollers 13 to the separator width L1 is preferably in the range of 0.2 to 0.4. Further, the length of the roller 13 being pressed to the separator (namely, a length of the square area in the longitudinal direction of the separator) is preferably equal to or more than the circumference of the winding core corresponding to the angle 72 degrees of the winding core (namely, one fifth of the circumference of the winding core) (in other words, one fifth of the circumference of the separator where the pressure joining portions are formed). It is more preferably equal to or more than the circumference of the winding core corresponding to the angle 90 degrees of the winding core (namely, one fourth of the circumference of the winding core), in addition, it is further more preferably equal to or more than the circumference of the winding core corresponding to the angle 180 degrees of the winding core (namely, a half of the circumference of the winding core). Moreover, the upper limit of the length of the roller 13 being pressed to the separator is preferably the circumference of the winding core corresponding to the angle 720 degrees of the winding core (namely, two of the circumference of the winding core). It is more preferably the circumference of the winding core corresponding to the angle 360 degrees of the winding core (namely, one of the circumference of the winding core).

For example, when the separator width L1 is 110 mm, as shown in FIG. 5, the lengths can be set in the following. The widths L3, L5, L7 of the rollers 13 are each 12 mm (the total is approximately 0.327 of L1). The intervals L4, L6 between the rollers 13 are each 20 mm, the length L2, L8 between the separator end and the rollers 13 are each 17 mm.

The knurling shape which is applied to the surface of the roller 13 can be HIRAME-type (the stripes of the convex shape horizontally in parallel), AYAME-type (the crossing shape of the two rows of the stripes of the convex shape, the stripes in each row are obliquely in parallel). And in knurling, the height of the convex portion, the angle, the module, or the like is determined considering the thickness of the separator. For example, as the thickness of the separator becomes thicker, the height is bigger, and the angle is sharp, and the module is determined according to these. For example, the height of the convex portion can be 0.05 mm to 0.5 mm, the module can be 0.2 to 0.5.

In addition, the number of the pressure joining portions are not limited, for example, determined based on the above knurling shape and the size of the pressure joining portion formed area 6.

### EXAMPLE 1

### Preparation of the Positive Electrode Plate

A positive-electrode active material of lithium cobalt oxide (LiCoO₂), a conductive agent of carbon powder, and a binding agent of polyvinylidene fluoride (PVdF) were sampled at a mass ratio of 94:3:3 and dissolved in an organic agent or the like of N-methyl-2-pyrrolidone (NMP) and then mixed together. Thus, a positive-electrode active material slurry was prepared. Next, this positive-electrode active material slurry was uniformly applied onto both surfaces of a positive-electrode core body made of an aluminum foil. This electrode plate was passed through a drier to remove the organic solvent (NMP). The positive-electrode active materials are formed on the positive-electrode core body. The slurry was not applied onto one edge of the positive-electrode core body along the longitudinal direction (the same edge on both surfaces of the positive-electrode core body). The non-applied edge of the positive-electrode core body was exposed to form the positive-electrode core-body exposed portion. The dried electrode plate was then compressed with force using a roll presser, and cut into the predetermined size, for example, into a strip shape of 4000 mm long, 110 mm wide.

### Preparation of the Negative Electrode

A negative-electrode active material made of graphite powder, carboxymethyl cellulose as a thickening agent, and styrene-butadiene rubber as a binding agent were sampled at a mass ratio of 95:3:2 and mixed with an appropriate amount of water. Thus, a negative-electrode active material slurry was prepared. Next, this negative-electrode active material slurry was uniformly applied onto both surfaces of a negative-electrode core body made of a copper foil. The slurry was not applied onto one edge of the negative-electrode core body along the longitudinal direction (the same edge on both surfaces of the negative-electrode core body). The non-applied edge of the negative-electrode core body was exposed to form the negative-electrode core-body exposed portion. This electrode plate was passed through a drier to remove the moist. The negative-electrode active materials are formed on the negative-electrode core body. Then, the dried electrode plate was compressed with force using a roll presser, and cut into the predetermined size, for example, into a strip shape of 4000 mm long, 110 mm wide.

### Preparation of Non-aqueous Electrolyte

As a non-aqueous solvent, ethylene carbonate (EC), ethyl methyl carbonate (EMC), and diethyl carbonate (DEC) were mixed at a volume ratio of 3:5:2 under the conditions of 25° C. and 1 atm. As electrolyte salt, lithium hexafluorophosphate (LiPF₆) was dissolved in the non-aqueous solvent at 1 M (mole/liter), thus preparing a non-aqueous electrolyte.

### Preparation of the Spiral Electrode Assembly

The two sheets of the separator 2 made of a microporous film of polyethylene (0.015 mm thick, 110 mm wide, 4500 mm long) penetrate and are inserted into the slit 1a of the winding core 1 (40 mm in diameter) made of a steel material for a carbon tool steel (SK material), as shown in FIG. 1(b). After this, through rotating the winding core 1 by one rotation, the separators 2 are wound to the one divided portion 1b of the winding core 1 divided by the slit (see FIG. 1(c)). Next, as shown in FIG. 1(d), the separators 2 wound to the other divided portion 1c of the winding core 1 are pressed to the rollers 13 (stainless steel, AYAME-type knurling on the surface, module 0.2) of the jig, then those are joined in pressure contact. This pressure joining is carried out to all the separators 2 wound to the other divided portion 1c (a half of the circumference of the winding core).

Next, the positive electrode plate and the negative electrode plate are providing such that the separator 2 is positioned at both surfaces of each of the positive electrode plate and the negative electrode plate, and the one edge of the positive electrode plate (core-body exposed portion) is projected beyond the one edge of the separator, and the one edge of the negative electrode plate (core-body exposed portion) is projected beyond the other edge of the separator. Further, by rotating the winding core 1 (total 25 rotations), the positive electrode plate and the negative electrode plate are wound. In the end, by removing the winding core 1, the spiral electrode assembly is prepared. And the steel material for the carbon tool steel is Hv 600 in Vickers hardness, harder than Hv 200 in Vickers hardness of the stainless steel.

### Assembly of the Cell

The above spiral electrode assembly was pressed into a flat electrode assembly. Overlapped areas of the core-body exposed portions are each welded to the positive electrode collector and the negative electrode collector. After this, the positive electrode collector and the negative electrode collector are each connected to the positive electrode external terminal and the negative electrode external terminal which are fixed to the sealing plate through an insulating member. The flat electrode assembly was inserted into the top opening portion of the prismatic cell case having the bottom, and the sealing plate was press-fitted to the top opening portion of the prismatic cell case, and such press-fitted portion was laser-welded. Then from an electrolyte injection aperture set on the sealing plate, a predetermined amount of the above non-aqueous electrolyte was injected, and the electrolyte injection aperture was sealed. Thus, the non-aqueous electrolyte secondary cell according to example 1 was prepared and completed.

### EXAMPLE 2

In manufacturing the spiral electrode assembly, the separator 2 made of a microporous film of polyethylene (0.050 mm thick, 130 mm wide, 4500 mm long) was used, and the winding core made of MC nylon (registered trade mark) (30 mm in diameter) was used. The separator 2 can be provided such that one sheet of the separator 2 is set at the slit of the winding core as shown in FIG. 3(a), by rotating the winding core by a half of the circumference the separator was wound in one layer to each of two winding core portions of the divided portion divided by the slit. After the separator was wound in two layers, the outer separator was pressed by the rollers 13 (stainless steel, AYAME-type knurling on the surface, module 0.2) of the jig shown in FIG. 6, and those are joined in pressure contact. Thus, the non-aqueous electrolyte secondary cell according to example 2 was prepared and completed in the same way as example 1 except joining in pressure contact by rotating the winding core by one and a half of the circumference. Further, stainless steel is harder than MC nylon (Rockwell hardness (R scale) 120).

Here in example 2, the knurling roller is shown in FIG. 6. And the separator width L1 is 130 mm, the width L3, L5, L7 of the roller 13 are each 16 mm (total approximately 0.369 L1), intervals L4, L6 between the rollers 13 are each 24 mm, and the length L2, L8 between the separator end and the rollers 13 are each 17 mm.

### Comparative Example 1

Except not joining in pressure contact by the knurling roller, the non-aqueous electrolyte secondary cell according to comparative example 1 was prepared and completed in the same way as the above example 1.

### Measurement of Winding Slippage

In the same way as above, the spiral electrode assemblies according to example 1, 2, comparative example 1 were each prepared at 100 pieces. Whether or not winding slippage of the separator positioned at the innermost circumference in the spiral electrode assembly occurs was checked by visual observation. When winding slippage occurs, the maximum value of winging slippage from the position at the beginning was measured. As a result, in the spiral electrode assemblies of example 1, 2, the winding slippage was 0. In the spiral electrode assemblies of comparative example 1, the winding slippage was 3 pieces. Further, the winding slippage values were 0.5 mm to 0.6 mm.

From this result, by structures or methods of those disclosure, the winding slippage in the spiral electrode assembly is remarkably suppressed or reduced.

In addition, the above examples are explained in the non-aqueous electrolyte secondary cell, but this disclosure is applied to batteries having the spiral electrode assembly in which the positive and negative electrode plates are wound interposing the separator therebetween regardless of a non-aqueous electrolyte battery or an alkaline battery, or regardless of a primary battery or a secondary battery. Further, the spiral electrode assembly includes a flat shape or a cylindrical shape. And as the cell case, a cylindrical cell case, a prismatic cell case, or a film type cell case using laminate film is available.

Here, the separator used in this disclosure is a microporous film, a nonwoven fabric, or the like. As a material of the separator need to be resistant to an electrolyte used, resin, glass fiber, or the like can be used. And a mixed materials of these or stacked layers of these can be used. In non-aqueous secondary batteries of these embodiments, preferably the separator made of resin can be used, especially the separator made of polyolefin is preferable. In addition, these embodiments can apply to the separator in which a heat resistant layer is formed on the surface of the separator made of polyolefin.

In the above embodiments, as the jig having the projection, the knurling roller type of the jig is used. But the projection in the jig is not limited to the knurling. And as a shape of the jig, a roller shape is preferable, then a board shape or a block shape can be used. Or a member having a curved surface corresponding to the shape of the winding core can be used. In the jig having the projection, the projection formed on the surface of the jig (the projection and the jig on which the projection is formed are formed integrally, and made of the same material.) is preferable, but a projection made of the same material as the jig or the different material from the jig can be fixed on the surface of the jig.

### INDUSTRIAL APPLICABILITY

As explained above, by these embodiments, the winding slippage of a winding core and winding members (a positive electrode plate and a negative electrode plate, a separator) is suppressed or reduced by a simple method. Therefore, industrial applicability is big.

### REFERENCE MARKS IN THE DRAWINGS

1: winding core
2: separator
3: winding body
4: jig
5: pressure joining portion
6: pressure joining portion formed area
11: head portion
12: roller axle portion
13: roller (roulette roller)
14: axle portion

1. A method for manufacturing a battery including a spiral electrode assembly comprising:
winding at least one sheet separator to a winding core, and forming an area in which the separator is overlapped in equal to or more than two layers of the separator;
joining the two layers mutually in pressure contact by pressing a projecting portion formed in a jig to the overlapped area;
after the step of the joining, providing a positive electrode plate and a negative electrode plate to the winding core, and winding into a spiral form the positive electrode plate and the negative electrode plate interposing the separator therebetween; and
after the step of the winding, forming a spiral electrode assembly by removing the winding core from a winding body wound into the spiral form.

2. The method for manufacturing a battery including a spiral electrode assembly according to claim 1, wherein the jig in which the projecting portion is formed is a roller.

3. The method for manufacturing a battery including a spiral electrode assembly according to claim 2, wherein in the step of the joining the roller is pressed to the overlapped area while winding the separator by rotating the winding core.

4. The method for manufacturing a battery including a spiral electrode assembly according to claim 2, wherein knurling is applied to the roller.

5. The method for manufacturing a battery including a spiral electrode assembly according to claim 1, wherein a hardness of a material of which the projecting portion is made is lower than a hardness of a material of which the winding core is made

6. The method for manufacturing a battery including a spiral electrode assembly according to claim 1, wherein a cross section shape of the winding core is a circle shape

7. A battery including a spiral electrode assembly winding into a spiral form a positive electrode plate and a negative electrode plate interposing a separator therebetween comprising:
an overlapped area in which the separator is overlapped in equal to or more than two layers of the separator in the center of the spiral electrode assembly; and
at least one pressure joining portion being formed joining in pressure contact the outer separator having the convex shape toward the winding center side to the inner separator positioned to the winding center side in the overlapped area.

8. The battery including a spiral electrode assembly according to claim 7, wherein plural pressure joining portions are provided in a square area, and a length of the square area in the longitudinal direction of the separator is equal to or more than one fifth of the circumference of the separator where the pressure joining portions are formed.

9. The method for manufacturing a battery including a spiral electrode assembly according to claim 1, wherein at the step of winding the at least one sheet separator to the wing core, the two sheets of the separators are wound.

10. The method for manufacturing a battery including a spiral electrode assembly according to claim 1, wherein at the step of winding the at least one sheet separator to the wing core, the one sheet of the separator is wound.
